(19) United States
(12) Patent Application Publication
(10) Pub. No.: US 2013/0015130 A1
(43) Pub. Date: Jan. 17, 2013

(54) PULSE AERATION FOR IMMERSED MEMBRANES

(71) Applicant: Joseph Breitner, Thornhill (CA)

(72) Inventor: Joseph Breitner, Thornhill (CA)

(21) Appl. No.: 13/181,776

(22) Filed: Jul. 13, 2011

(51) Int. Cl. B01D 65/02; B01D 29/60; B01D 29/66

(52) U.S. Cl. 210/636; 210/151; 210/137

(57) ABSTRACT

An assembly of modules on the order of a cassette or larger are aerated simultaneously in a series of air-on or high flow rate periods, each in the range of 0.5 to 20 seconds long, separated by longer air-off or low flow rate periods, each in the range of 5 to 40 seconds long. A plurality of aerators located in association with a plurality of modules are provided with a burst of air simultaneously from a shared air accumulator or pulsator connected to all of the aerators. The air accumulator or pulsator may be fed with a continuous supply of air. The plurality of modules may be connected together in a cassette or rack. The accumulator or pulsator may be located outside of a tank of water containing the membranes.

### FIELD

The present disclosure relates to submerged membrane filtration and particularly to using scouring air bubbles produced by an aeration system to clean or inhibit the fouling of membranes in a submerged membrane filter.

### BACKGROUND

The following discussion is not an admission that anything discussed below is common knowledge or citable as prior art.

Immersed membranes are used, for example, for filtering water in municipal water supply treatment plants and in wastewater treatment plants. The membranes may be microfiltration or ultrafiltration membranes made in the form of modules of hollow fiber membranes. In large plants, many modules are immersed in the water to be filtered in an open tank and filtered water, also called permeate, is withdrawn through the membranes by suction. In a typical filtration cycle, a period of permeation, for example for 15 minutes to an hour, is followed by a relatively short period of backwashing or relaxation, and then the cycle repeats. In wastewater plants, and also in some water supply plants, the membranes are scoured with bubbles during permeation to clean or inhibit fouling in the membranes. The bubbles are provided according to an aeration regime that is applied throughout most, and possibly all, of the permeation part of the filtration cycle, and possibly during the backwash or relaxation part of the cycle as well. The aeration regime uses a significant amount of energy, adding to the cost and environmental impact of the plant. Accordingly, there have been various attempts to reduce the energy required by the aeration regime while still maintaining an acceptable fouling rate in the membranes.

A cyclic aeration system is described in International Publication Number WO 2000/021890, published April 20, 2000. In a version of this system used by GE Water and Process Technologies with its ZeeWeed™ hollow fiber membrane modules, air from one or more blowers is split through a set of controlled valves into two or four sets of aerators. The valves distribute the air to the sets of aerators in turn. For example, with two sets of aerators the air may be sent first to one set of aerators and then to the other set of aerators. Several filtration modules are connected together in a frame to provide a larger unit called a rack or cassette. There are typically several aerators below a cassette, but all of these aerators are part of the same set of the aerators. In this case, the cassette experiences an aeration regime wherein bubbles are provided for a period of time, and then not generally provided for a period of time, in repeated cycles. For example, with two sets of aerators, bubbles may be provided to a cassette for 10 seconds out of every 20 seconds. This is also called a 10 seconds on, 10 seconds off cycle, or simply a 10, 10 cycle. With four sets of aerators, bubbles may be provided to a cassette for 10 seconds out of every 40 seconds, or in a 10, 30 cycle. In some plants, the valve set allows the system to switch between these two regimes depending, for example, on variations in the fouling qualities of the water or the feed flow rate.

In the Mempulse™ system by Siemens Water Technologies Corp., each module is provided with an integrated pulsing air lift pump. Each module in a rack or cassette also has an air tube connecting its air lift pump to a common air supply pipe. The air tube discharges air into an inverted cup in the pulsing air lift pump. A pocket of air grows inside the cup until it extends downwards to a critical elevation, at which point most of the air in the pocket discharges into a vertical passageway. The passageway is open at its bottom end to draw in water in the tank, and its top is open to gaps in a lower potting head of the module. An air lift is formed in the passageway, and bubbles and water are discharged through the gaps into the module. The module experiences an aeration regime that, as in the cyclic aeration system, consists essentially of an air on—air off cycle. The precise timing of the cycle in commercial systems is not known to the inventor, but the related International Publication Number WO 2008/153818, published Dec. 18, 2008 suggests a cycle of roughly 2 seconds of bubbles, with entrained water, followed by 8 seconds without bubbles.

### INTRODUCTION TO THE INVENTION

The cyclic aeration system has proven to be generally at least as effective as continuous aeration in inhibiting fouling while requiring only one half the amount of air. The Mempulse™ system avoids using controlled valves, but the pulsing air lift pumps might sometimes be fouled by solids in the wastewater. Their location at the bottoms of the modules would make the air lift pumps difficult to monitor and service if they did foul. The 2-8 cycle appears to use less air than a 10-10 or 10-30 cycle because the air is on for a lesser percentage of the entire cycle time but the air flow rate in the air on time, which is unknown to the inventor, would also need to be considered in determining how much air is used in each regime.

In International Publication Number WO 2008/153818, the inventors of the air cycling system noted that a burst of large bubbles produced at the start of an air on period might be particularly effective at cleaning the membranes. The Mempulse™ system might seem to take advantage of such a burst of bubbles, but if so the effect is diminished by other aspects of the system. In particular, some of the energy of the bubbles is spent in drawing water through the air lift pumps. Further, the air-on periods cannot be made to start at the same time for any particular set of modules. Considering several modules in a rack each with its own air lift pump, slight variations in the size or shape of components in the air lift pumps, or in the depth of water over the air lift pumps, or movement of water in the tank, will cause slight variations in the cycles. One air lift pump might operate according to a 2-8 cycle, while another operates according to a 2.1-8 cycle, another at 1.9-8.1, another at 2-8.1 and so on. There are thousands of cycles in a day, and so differences of even one tenth of a second would accumulate to the point where one air lift pump releases bubbles in the air-off period of another air lift pump. Considering, for example, 10 modules in a rack, on average 2 air lift pumps could be releasing bubbles at all times. The center to center distance between modules is very small, possibly one fifth or less, relative to the height of the modules and so a pulse of water and air rising through one module is likely to also entrain some water in an adjacent module. The release of air from 2 air lifts pumps in a rack on average at all times is likely to create a persistent upwards flow of water through the rack. The effect observed in the context of the air cycling system, however, was of a burst of bubbles being released into essentially still water. Releasing a burst of bubbles into upwards moving water is not likely to be as effective.

In a process described herein, an aeration regime comprising bursts of bubbles is applied simultaneously to one or more aerators located in association with an assembly of filtering membranes, such as a rack or cassette of membrane modules. The bursts are provided by accumulating gas under pressure in a plenum and then releasing a burst of the gas from the plenum to the one or more aerators. The one or more aerators may provide bubbles to an area that has a span of at least one quarter of the height of the assembly of membranes. The aeration regime may comprise, for example, a series of air-on or high flow rate periods, each in the range of 0.5 to 4 seconds long, separated by longer air-off or low flow rate periods, each in the range of 5 to 40 seconds long. Alternatively, longer air—on periods of 4 to 20 seconds may also be provided. The plenum may be located outside of a tank holding the rack or cassette, and it may be fed with a continuous supply of gas.

In an apparatus described herein, one or more aerators associated with a plurality of membrane modules are connected to the output side of a shared plenum. The plurality of modules may be connected together in a cassette or rack. The plenum may be located outside of a tank of water containing the membranes. The plenum may be fed with a continuous supply of gas, for example from one or more air blowers operating at a generally continuous speed. The release of gas may be provided from a pressure sensitive automatic valve or from a controlled valve.

By way of any of the processes or apparatus described above, an aeration regime is provided with a gas flow rate that varies in time. However, the plenum which produces the variation in flow rate may be located outside of the wastewater in the membrane tank where it is not exposed to wastewater and where it may be easily monitored and serviced. Further, a single plenum may supply gas to a set of aerators under an assembly of modules, such as a cassette or rack. The set of aerators associated with a rack or cassette may all receive a burst of air at the same time. If the set of aerators has a sufficient span relative to its depth of submergence, most of the water in the area of the cassette or rack may be allowed to become generally still between bursts. At the start of a burst, bubbles are released into still water which maximizes the velocity of the bubbles relative to the water.

### BRIEF DESCRIPTION OF THE DRAWINGS

One or more embodiments of the invention will now be described, by way of example, with reference to the attached Figures.

FIG. 1 shows a water treatment system in top view.

FIG. 2 shows the water treatment system of FIG. 1 in end view.

FIG. 3 shows an aeration device of the water treatment system of FIG. 1.

FIG. 4 shows a plurality of membrane modules connected in a cassette.

FIGS. 5A to 5D show a device for producing bursts of a gas.

### DETAILED DESCRIPTION

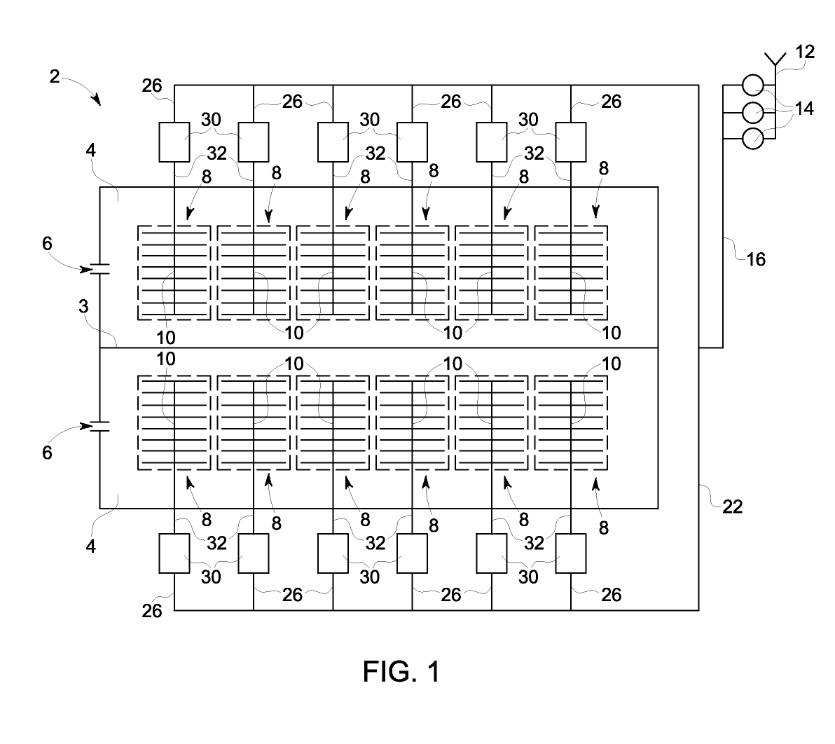

FIG. 1 shows a water treatment system 2 from a top view. The water treatment system 2 has one or more filtration tanks 4. If there are multiple tanks 4, they may be aligned in parallel and separated by a partition wall 3. Each tank 4 accepts feed water through an inlet 6. Water may be removed from a tank 4 through one or more of a permeate withdrawal system, a drain and a recycle conduit, which are not shown to simplify FIG. 1 since they are conventional parts of a water treatment system using immersed membranes.

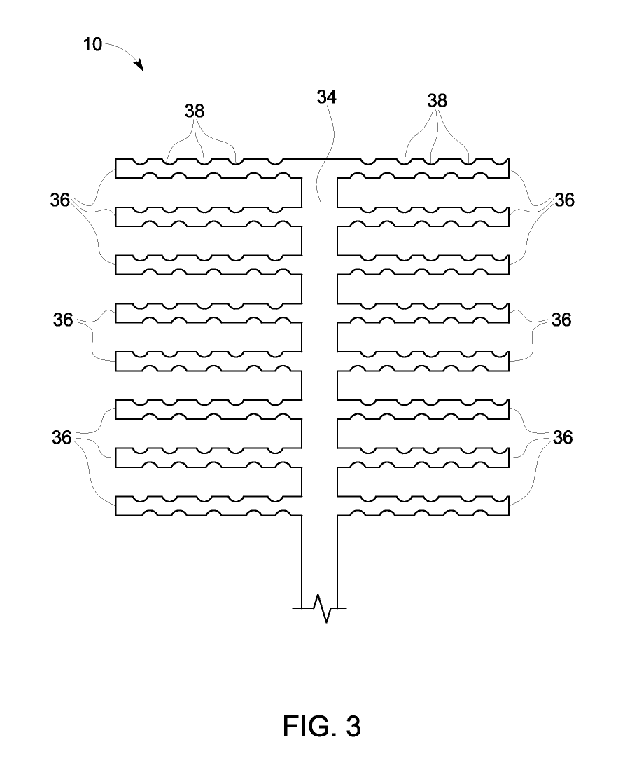

The tank 4 has one or more membrane assemblies 8 shown in dashed lines in FIG. 1. During filtration, the membrane assemblies 8 are used to withdraw permeate from water in the tank 4 while rejecting solids, which remain in the tank 4 until they are digested, drained or removed in a recirculation line. An aerator assembly 10 is associated with each membrane assembly 8. The aerator assembly 10 provides bubbles which rise through the associated membrane assembly 8 to scour or clean its membranes. The aerator assembly 10 may include a plurality of aerators of various types, including for example a network of pipes with holes drilled in them to emit bubbles as will be described in more detail in relation to FIG. 3.

To provide air to the aerator assembly 10, air is drawn in through an air inlet 12 to a set of blowers 14. The blowers 14 may operate at a generally constant speed, thus providing a generally constant flow rate of air. By turning off one or more of the blowers 14, or reducing the speed of one or more of the blowers, a different flow rate of air can be provided. However, turning a blower 14 on an off frequently, or varying its speed often, can reduce the life of the blower 14. Accordingly, it is preferable to leave the blowers 14 either on or off, and operate them at a constant speed, for at least an hour or more at a time. Alternatively, systems can be provided to supply other gases, such as nitrogen, oxygen or oxygen enriched air or biogas.

The gas travels through a blower outlet pipe 16 to one or more manifolds 22. The manifolds 22 deliver the gas to one or more inlets 26 of one or more plenums 30. Gas accumulates in the plenum 30 by increasing in pressure, optionally in combination with expansion of the plenum 30. When gas is released from the plenum 30, the gas flows through a plenum outlet 32 to one or more of the aerator assemblies 10. As will be described further below, gas is released from the plenum 30 in bursts, causing corresponding bursts of bubbles to be emitted from the one or more aerator assemblies 10 connected to the plenum 30.

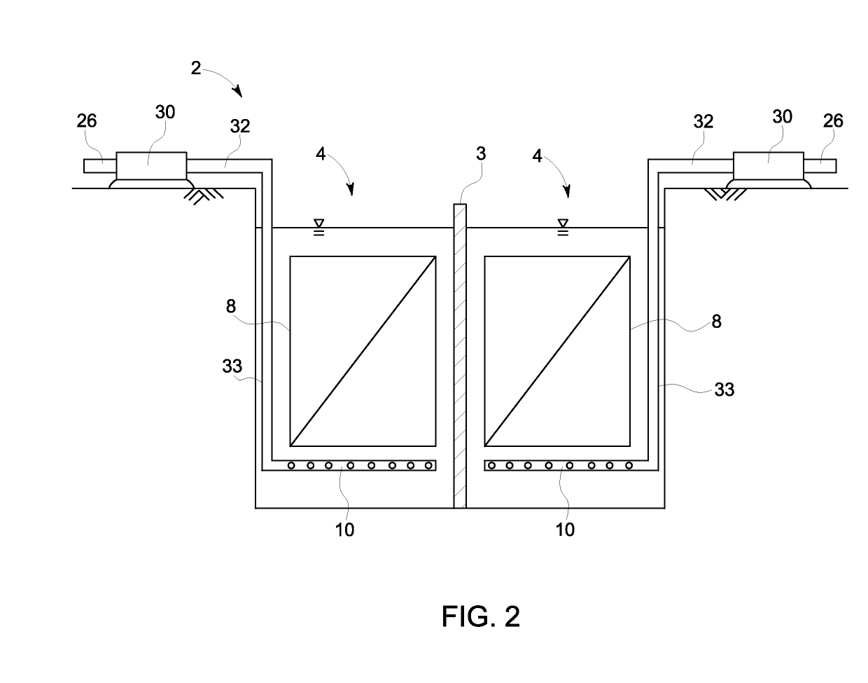

FIG. 2 shows the water treatment system 2 of FIG. 1 in a cross sectioned end view. As shown, a membrane assembly 8 is positioned above an aerator assembly 10, although the aerator assembly 10 may also be integrated with the membrane assembly 8. The aerator assembly 10 is connected to a plenum outlet 32 by a feeder pipe 33. The plenum 30 is located outside of the tank, where it can be reached for servicing and operate under ordinary atmospheric pressure. Bubbles released from an aerator assembly 10 float towards the surface of the water in the tank 4. As they do so, the bubbles pass through the membrane assembly 8 to scour the membranes, thus cleaning them or decreasing their rate of fouling.

As shown in FIGS. 1 and 2, the aerator assembly 10 provides bubbles to a volume of water defined by a depth of water covering an area, in plan view, spanned by the aerator assembly. A column of bubbles may expand horizontally as it rises, but the span 11 of the aerator assembly 10 can be considered to be the horizontal distance across the aerator assembly, or more conservatively between two openings on opposite sides of the aerator assembly 10. If the span 11 could be measured along one of multiple lines drawn across the aerator assembly 10, then the smallest of these lines is used to measure the span 11. If a set of multiple aerator assemblies 10 are connected to a common plenum 30, then they are considered as one assembly and the span is measured across the set.

The span 11 is preferably significant in length relative to the depth of submergence of the one or more aerator assemblies, which is typically also related to the height of membrane assemblies 8. For example, the span 11 may be one quarter or more, or one third or more, or one half or more, of either the depth of submergence of the aerator assembly 10 or the height of a membrane assembly 8. The extent to which a column of bubbles rising through one membrane assembly 8 could lift water in an adjacent membrane assembly 8 depends in part on the vertical distance that the bubbles rise through. Providing a significant span 11 relative to that vertical distance inhibits bubbles produced from one aerator assembly 10 from causing water to rise over an adjacent aerator assembly 10. Water in a membrane assembly 8 can therefore come closer to being still between bursts of air from its associated aerator assembly 10. When a burst of bubbles is provided to a membrane assembly 8, the bubbles are released into water that does not already have a significant upwards velocity. In addition to the comment mentioned previously in International Publication Number WO 2008/153818, the potential benefit to releasing bubbles into still water, rather than rising water, was discussed in Reexamination of the Gas Sparging Mechanism for Membrane Fouling Control, by Masao Kondo et al.

In operation, gas is emitted from a plenum 30, and bubbles are provided from an aerator assembly 10, at a rate that varies in repeated cycles. Each cycle may include a period during which gas accumulates in the plenum 30, followed by the release of a burst of the gas. Alternatively, a cycle may be described as having an “air-on” time and an “air-off” time. The flow rate during the burst, or air on time, could be generally constant or might rise to a peak flow rate and then decline again. There may be an abrupt transition to the accumulation stage, or air off time, during which the flow of gas may be completely stopped. Alternatively, the flow rate in the air on time may decrease gradually and the air air-off time may be deemed to occur when the rate of gas flow from the outlet 32 of a plenum 30 is 10% or less of the peak gas flow rate in the air on time. The duration of the burst, or air on time, may be between 0.5 and 20 seconds or between 0.5 and 4 seconds. The duration of the accumulation stage, or air off time, may be between 5 and 40 seconds.

In the system 2 shown in FIG. 1, the timing of bursts of gas from the various plenums 30 is not intentionally synchronized. Although aerator assemblies 10 might emit their first burst of bubbles at the same time, over time the cycles of different aerator assemblies 1 may diverge from each other. However, due to the spacing of the aerator assemblies 10 relative to their depth of submergence, each membrane assembly 8 experiences flows of bubbles and entrained water that are determined primarily by its associated aerator assembly 10.

FIG. 3 shows an aerator assembly 10 in greater detail. The aerator assembly 10 has a header pipe 34. The header pipe 34 is connected to the feeder pipe 33 shown in FIG. 2 and so receives gas from the outlet 32 of the plenum 30. A plurality of individual aerators 36 extend from the header pipe 34. Each of the aerators 36 shown is essentially a section of pipe having holes 38 provided in its sides to release bubbles into the water, although other types of aerators may also be used.

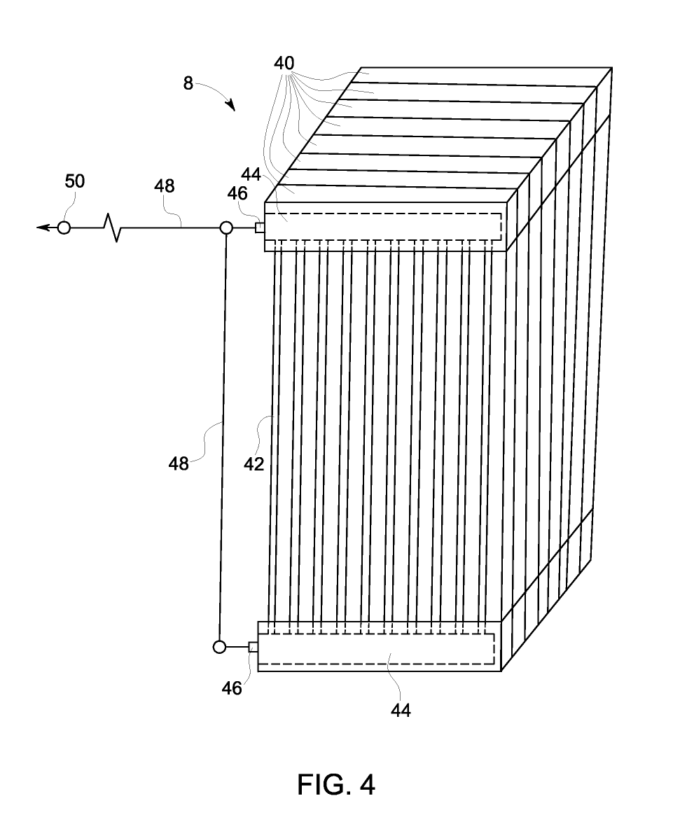

FIG. 4 shows a membrane assembly 8 in greater detail. The membrane assembly 8 has a plurality of membrane modules 40 arranged side by side. The modules 40 may be connected to each other or to a common frame (not shown). Each of the plurality of membrane modules 40 has hollow fiber membranes 42 oriented generally vertically between two potting heads 44. The ends of the membranes 42 are connected to potting heads 44 by a watertight connection that allows permeate to be collected in at least one of the potting heads 44.

A potting head 44 may have a spigot 46 which is connected to one or more permeate collection pipes 48. The permeate connection to only one of the modules 40 is shown to simplify FIG. 2 but typically all of the modules 40 in an assembly 8 would be connected at some point to a common permeate collection pipe 48. The permeate collection pipes 48 are connected to a permeate pump 50. When the permeate pump 50 is operated, a negative pressure is created in the membranes 42 relative to water in the tank 4 surrounding the membranes 42. The resulting transmembrane pressure draws water through the membranes 42.

A membrane assembly 8 can also be made according to other configurations. For example, modules 40 of vertically oriented membranes 42 may be round or square and connected together in rows or grids to form a assembly 8. Module 40 may have also have hollow fiber membranes 42 oriented horizontally. Modules 40 with horizontal membranes may arranged into an assembly 8 by placing them side by side or in grids, or by stacking them on top of each other, or both. Modules 40 may also have flat sheet membranes, and may be arranged into an assembly 8 by placing them side by side or in grids, or by stacking them on top of each other, or both.

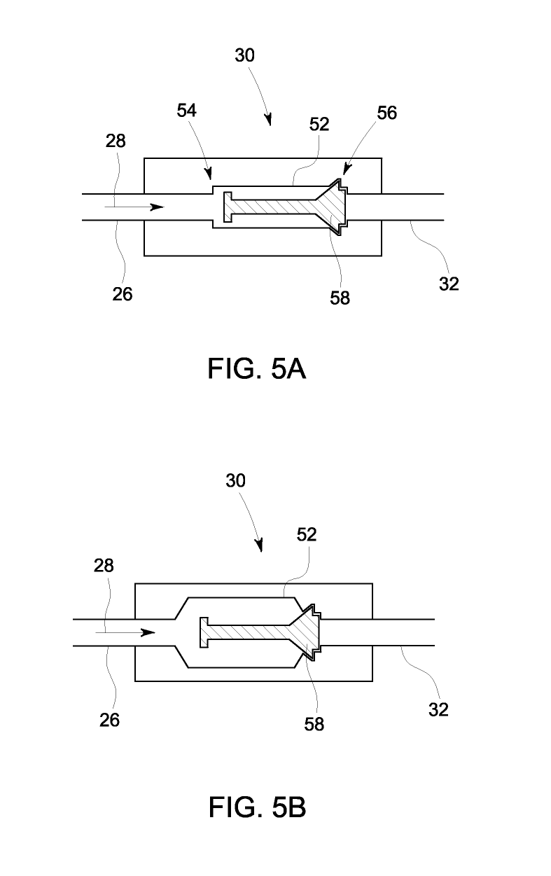

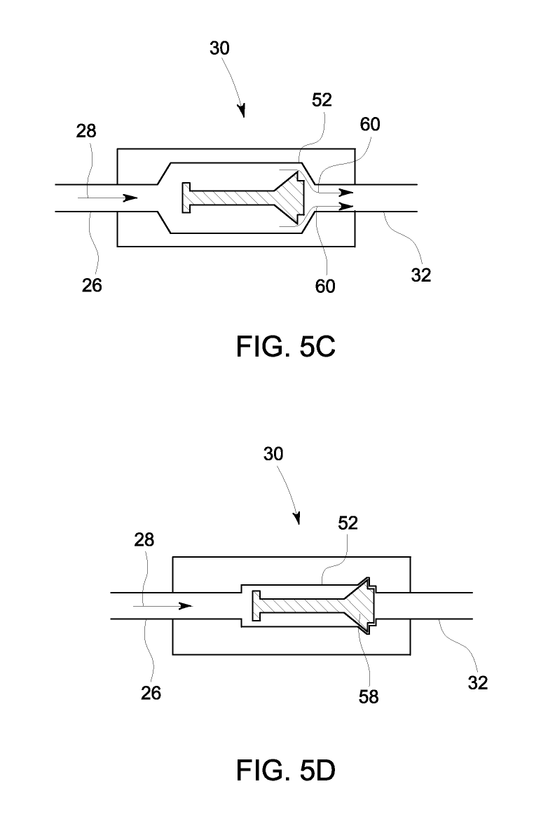

FIGS. 5A to 5D show an example of a plenum 30 in sequential stages of operation. The plenum 30 of FIGS. 5A to 5D has a flexible membrane 52 with a first end 54 connected to an inlet 26. A second end 56 of the flexible membrane 52 is connected to the an outlet 32. A stopper 58 is provided at the second end 56. The stopper 58 and the second end 56 cooperate to form a valve which prevents air from exiting from the flexible membrane 52 until a threshold pressure within the flexible membrane 52 is reached. When the threshold pressure is reached, the second end 56 expands so that the seal between the stopper 58 and the second end 56 is released.

As shown in FIG. 5B, the flexible membrane 52 expands as air accumulates therein. In FIG. 5C, the air pressure in the flexible membrane 52 reaching the threshold pressure causes the second end 56 to expand and release the seal with the stopper 52. When this happens, air passes by the stopper 52 and through the outlet 32. A burst of air is released from the flexible membrane 52. As the air exits from the flexible membrane 52, the flexible membrane 52 contracts to its initial unpressurized state as shown in FIG. 5D. The stopper 58 again forms a seal with the second end 56 and the process of filling the flexible membrane 52 with air repeats. Alternatively, a plenum 30 in the form of a generally rigid tank or reservoir may be provided and a more conventional valve can be provided between the plenum 30 and the outlet 32. The valve may be configured to open automatically when the threshold pressure is reached, and to stay open until a lower threshold pressure is reached. This may be done mechanically using a pressure sensitive valve, or by using a pressure sensor, a controller and an actuated valve. Alternatively, the valve may be opened by a timer, and kept open for a pre-determined period of time. In a case where air is released when the air reaches a threshold pressure, the frequency or timing of busts of gas can be controlled by controlling the flow rate of gas to the plenum 30, or possibly by venting gas from the plenum 30 or before it reaches the plenum 30.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

I claim:

1. A process for providing bubbles to an assembly of filtering membranes immersed in water in a tank during an aeration period, comprising the steps of:
a) accumulating gas in a plenum;
b) releasing a burst of the gas from the plenum to a set of one or more aerators, the set of one or more aerators associated with the assembly of immersed filtering membrane modules; wherein
steps a) and b) are repeated one after the other throughout the period of aeration, and
the one or more aerators provide bubbles to an area that has a span that is at least one quarter of the height of the assembly of filtering membranes.

2. The process of claim 1 wherein the one or more aerators comprise a plurality of openings for discharging bubbles and the span is measured between a pair of the openings spaced on opposite sides of a line along the shortest distance across the one or more aerators.

3. The process of claim 1, wherein step a) has a duration of between 0.5 and 20 seconds and step b) has a duration of between 5 and 40 seconds.

4. The process of claim 3, wherein step a) has a duration of between 5 and 20 seconds.

5. The process of claim 1, further comprising a step of feeding a supply of the pressurized gas to the plenum throughout step a) and step b).

6. The process of claim 1, wherein the plenum is positioned outside of the water in the tank.

7. The process of claim 6, wherein the plenum comprises an expandable chamber.

8. The process of claim 1, wherein the assembly of filtering membranes immersed comprises a plurality of distinct modules connected together into a cassette.

9. The process of claim 8, wherein the set of one or more aerators comprises a plurality of chambers, each chamber having a plurality of openings for discharging bubbles, each of the plurality of chambers being in fluid connection with the plenum through a shared manifold.

10. A process for providing bubbles to an assembly of filtering membranes immersed in water in a tank, comprising the steps of:
a) accumulating pressurized gas in a plenum;
b) releasing the gas from the plenum in bursts through a manifold to a set of two or more aerators, the set of two or more aerators associated with the assembly of immersed filtering membrane modules.

11. The process of claim 10, wherein step a) has a duration of between 0.5 and 4 seconds and step b) has a duration of between 5 and 40 seconds.

12. The process of claim 10, wherein in step a) a conduit between the plenum and the one or more aerators is closed and in step b) the conduit is open.

13. The process of claim 10, wherein the plenum is positioned outside of the water in the tank.

14. The process of claim 10, wherein the plenum comprises an expandable chamber.

15. The process of claim 10, wherein the assembly of filtering membranes comprises a plurality of distinct modules connected together into a cassette.

16. An apparatus to provide bubbles to an assembly of filtering membranes immersed in water in a tank, comprising:
a) a plurality of aerators;
b) a plenum connected to an inlet and an outlet in fluid communication with the plurality of aerators; and,
c) a valve between the plenum and the outlet, the valve configured to release gas from the plenum in bursts.

17. The apparatus of claim 16, wherein the assembly of filtering membranes comprises a plurality of distinct modules connected together in a cassette.

18. The apparatus of claim 16, wherein the plenum is positioned outside of the water in the tank.

19. The apparatus of claim 16, wherein the plenum comprises an expandable chamber.

20. The apparatus of claim 16, wherein the valve is configured to open communication to the plurality of aerators in response to the gas in the plenum reaching a threshold pressure.

21. The apparatus of claim 20, wherein the plenum comprises an expandable chamber and a stopper, wherein the chamber and stopper form a seal preventing air from exiting the chamber when the chamber is at a pressure below the threshold pressure, the seal being released when the threshold pressure is reached.

22. The apparatus of claim 16, comprising a manifold in communication between the outlet and the plurality of aerators.
